(19) United States
(12) Patent Application Publication
(10) Pub. No.: US 2020/0327749 A1
(43) Pub. Date: Oct. 15, 2020

(54) VEHICLE INFOTAINMENT APPARATUS AND CONTROLLING METHOD THEREOF

(71) Applicant: DAESUNG ELTEC CO., LTD., Seoul (KR)

(72) Inventor: Jong Sik MO, Gyeonggi-do (KR)

(73) Assignee: DAESUNG ELTEC CO., LTD., Seoul (KR)

(21) Appl. No.: 16/916,628

(22) Filed: Jun. 30, 2020

Related U.S. Application Data
(63) Continuation of application No. PCT/KR2018/006000, filed on May 28, 2018.

(30) Foreign Application Priority Data
Apr. 6, 2018 (KR) 10-2018-0040606

(51) Int. Cl. G07C 5/08; B60K 35/00; B60R 16/023

(52) U.S. Cl. CPC G07C 5/0825; B60K 35/00; B60K 2370/167; B60K 2370/164; B60R 16/023

(57) ABSTRACT

Provided are a vehicle infotainment apparatus and a control method thereof. When a cluster is in an abnormal state, the vehicle infotainment apparatus or an in-vehicle information (IVI) apparatus backs up a cluster function to stably control vehicle information to be displayed by the cluster.

### CROSS-REFERENCE TO RELATED APPLICATIONS

This application is a continuation of PCT/KR2018/006000, filed on May 28, 2018, which claims priority to and the benefit of Korean Patent Application No. 10-2018-0040606, filed on Apr. 6, 2018, in the Korean Intellectual Property Office, the disclosures of which are incorporated herein in their entireties by reference.

### TECHNICAL FIELD

The present disclosure relates to a vehicle infotainment apparatus and a controlling method thereof.

### BACKGROUND

Various vehicle safety apparatuses have been developed and installed in vehicles for the convenience and safety of drivers. More specifically, a vehicle safety apparatus may include a safety assisting apparatus such as a lane departure warning apparatus that assists a driver during a steering operation to prevent the driver from departing from a driving lane while driving the vehicle, and an additional service providing apparatus, such as a navigation device, which provides a route to a designation selected by the driver and additional information with respect to the route. The above-described navigation device may be an audio video navigation (AVN) apparatus capable of providing not only route navigation information but also audio and video functions such as music, movies, radio, etc.

Generally, vehicles have been provided with clusters that provide drivers with information related to driving and operating states of various apparatuses such as an engine. A cluster includes a speedometer that measures and controls the instantaneous speed of the vehicle, an interval meter, an integrating meter, a revolutions per minute (RPM) speed meter that indicates the number of revolutions of the engine, a fuel system that indicates a remaining amount of fuel, a cooling water thermometer that indicates the temperature of cooling water, and the like.

The cluster may be an analog or digital cluster. In recent years, digital clusters that display various types of vehicle information in a digital form have been popularized.

Such clusters display a lot of important information that is essential for driving, and thus, it is required that this information be displayed normally under any circumstances. When it is necessary to reset or reboot a digital cluster for some reasons, a serious hazard to road driving may occur.

### SUMMARY

Provided are a vehicle infotainment apparatus and a controlling method thereof capable of stably controlling vehicle information that is to be displayed on a cluster even when the cluster is in an abnormal state, by backing up a cluster function in the vehicle infotainment apparatus or an in-vehicle information (IVI) apparatus.

According to an aspect of the present disclosure, a vehicle infotainment apparatus includes a cluster monitoring unit configured to monitor a state of a cluster displaying vehicle information including at least one of a vehicle speed of a vehicle and a number of revolutions per minute of an engine of the vehicle; and a control unit configured to receive state information of the cluster from the cluster monitoring unit and set a cluster backup function according to the received state information, wherein, when the cluster monitoring unit detects an abnormal state of the cluster, the control unit is configured to set the cluster backup function.

The control unit may be configured to control the cluster to display the vehicle information on a screen of the cluster according to the cluster backup function.

The vehicle infotainment apparatus may further include a vehicle information receiving unit connected to a vehicle control apparatus through a controller area network (CAN) communication interface and configured to receive the vehicle information from the vehicle control apparatus through the CAN communication interface.

When the cluster monitoring unit detects a normal state of the cluster, the control unit may be configured to release the set cluster backup function.

The vehicle infotainment apparatus may further include a data interface configured to receive the state information from the cluster; and a display interface configured to transmit image information corresponding to the vehicle information to the cluster.

The cluster monitoring unit may be connected to the cluster through a data interface and is configured to monitor a state of the cluster by receiving a heartbeat message from the cluster.

The control unit may be connected to the cluster through a display interface and configured to transmit image information corresponding to vehicle information to a screen of the cluster through the display interface when the cluster is in an abnormal state.

The image information may be same as a graphical user interface of the image information displayed on the screen when the cluster is in a normal state.

The image information may be different from a graphical user interface of the image information displayed on the screen when the cluster is in a normal state.

According to another aspect of the present disclosure, a control method of a vehicle infotainment apparatus includes monitoring a state of a cluster displaying vehicle information including at least one of a vehicle speed of a vehicle and a number of revolutions per minute of an engine of the vehicle; receiving state information of the cluster from the cluster monitoring unit; and setting a cluster backup function according to the received state information, wherein the setting includes, when an abnormal state of the cluster is detected, setting the cluster backup function.

The setting may include controlling the cluster to display the vehicle information on a screen of the cluster according to the cluster backup function.

The control method may further include: receiving the vehicle information from the vehicle control apparatus through a controller area network (CAN) communication interface.

The control method may further include: releasing the set cluster backup function when a normal state of the cluster is detected.

According to another aspect of the present disclosure, a vehicle infotainment apparatus includes a cluster monitoring unit connected to a cluster displaying vehicle information including at least one of a vehicle speed of a vehicle and a number of revolutions per minute of an engine of the vehicle through a data interface and configured to monitor a state of the cluster based on a cluster state signal received through the data interface; a vehicle information receiving unit connected to a vehicle control apparatus controlling the vehicle through a controller area network (CAN) communication interface and configured to receive the vehicle information from the vehicle control apparatus through the CAN communication interface; and a control unit connected to the cluster through a display interface and configured to set a cluster backup function and transmit image information corresponding to the vehicle information received by the vehicle information receiving unit to the cluster through the display interface, when the cluster monitoring unit detects an abnormal state of the cluster.

According to another aspect of the present disclosure, a cluster apparatus includes a cluster monitoring unit mounted on the vehicle and configured to monitor a state of a cluster displaying one or more information of a vehicle speed of the vehicle or a number of revolutions per minute of an engine of the vehicle; and a communication interface unit configured to communicate with an infotainment apparatus mounted on the vehicle, wherein, when a display of the cluster does not normally operate, the cluster monitoring unit is configured to transmit a cluster malfunction signal to the infotainment apparatus through the communication interface unit.

When the cluster malfunction signal is transmitted to the infotainment apparatus, a screen of the cluster apparatus may be controlled by the infotainment apparatus.

When it is determined that the cluster is operating normally again, the cluster monitoring unit may be configured to transmit a normal operation signal to the infotainment apparatus through the communication interface unit.

According to another aspect of the present disclosure, a method of controlling a cluster apparatus of a vehicle, wherein the cluster apparatus is communicably connected to an infotainment apparatus mounted on the vehicle, includes: determining, by the cluster apparatus or the infotainment apparatus, whether the cluster apparatus malfunctions; when the cluster apparatus malfunctions, transmitting, by the cluster apparatus, a malfunction signal to the infotainment apparatus; controlling, by the infotainment apparatus, a display of the cluster apparatus; and when the cluster apparatus normally operates, transmitting, by the cluster apparatus, a normal operation signal to the infotainment apparatus.

The method may further include: ending, by the infotainment apparatus, a control of the display of the cluster apparatus upon receipt of the normal operation signal by the infotainment apparatus.

According to another aspect of the present disclosure, a non-transitory computer readable recording medium having embodied thereon a program for executing a method of controlling a vehicle infotainment apparatus in a computer is provided.

The vehicle infotainment apparatus and the controlling method thereof according to embodiments may stably control vehicle information that is to be displayed on a cluster when the cluster is in an abnormal state by backing up a cluster function in the vehicle infotainment apparatus or an in-vehicle information (IVI) apparatus.

### BRIEF DESCRIPTION OF DRAWINGS

FIG. 1 is a conceptual diagram for explaining a cluster and a vehicle infotainment apparatus according to an embodiment.

FIG. 2 is a schematic block diagram of the cluster and vehicle infotainment apparatus shown in FIG. 1.

FIG. 3 is a schematic block diagram of a cluster and a vehicle infotainment apparatus according to another embodiment.

FIG. 4 is a schematic block diagram of a cluster and a vehicle infotainment apparatus according to yet another embodiment.

FIG. 5 is a flowchart for explaining a control method of a vehicle infotainment apparatus according to still another embodiment.

FIG. 6 is a detailed block diagram of a vehicle infotainment apparatus according to another embodiment.

FIG. 7 is an example diagram illustrating a cluster and a vehicle infotainment apparatus implemented as one device according to another embodiment.

FIG. 8 is an example diagram illustrating a cluster and a vehicle infotainment apparatus implemented as one device according to yet another embodiment.

### DETAILED DESCRIPTION OF EMBODIMENTS

Terminology used in the present specification will now be briefly described before describing the disclosure in detail.

Although the terms used in the following description are selected, as much as possible, from general terms that are widely used at present while taking into consideration of the functions in the disclosure, these terms may be replaced by other terms based on intentions of one of ordinary skill in the art, precedents, emergence of new technologies, or the like. In a particular case, terms that are arbitrarily selected by the applicant may be used. In this case, the meanings of these terms will be described in detail in the description of the disclosure. Therefore, it is noted that the terms used herein are construed based on practical meanings thereof and the description throughout the present specification, rather than being simply construed based on names of the terms.

It will be understood that the terms “comprises,” “comprising,” “includes” and/or “including,” when used herein, specify the presence of stated elements, but do not preclude the presence or addition of one or more other elements. The term “part” or “module” is used to denote an entity for performing at least one function or operation, and may be embodied as, but is not limited to, a software element or a hardware element.

In the embodiment, a vehicle infotainment apparatus is not limited to the term, but means an apparatus mounted on a vehicle and providing various types of information and multimedia functions. Examples of the vehicle infotainment apparatus may include a navigation apparatus, an audio video navigation (AVN) apparatus, and an in vehicle information (IVI) apparatus.

In the embodiments, a cluster means a vehicle dashboard apparatus that provides all information related to driving and operation state information of various apparatuses such as an engine to a driver. The cluster may be an analog cluster or a digital cluster and other. The cluster may include a micro processing unit (MPU) or a processor and a display panel.

Hereinafter, embodiments will be described in detail with reference to the accompanying drawings.

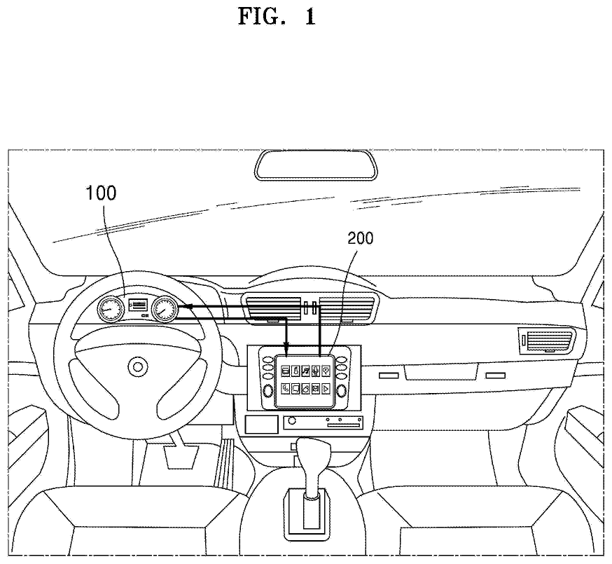

FIG. 1 is a conceptual diagram for explaining a cluster 100 and a vehicle infotainment apparatus 200 according to an embodiment.

Referring to FIG. 1, the cluster 100 may be provided on the front of a driver's seat inside a vehicle, and the vehicle infotainment apparatus 200 may be provided in the center of dashboard inside the vehicle. A display of the cluster 100 may be provided on a dashboard in the driver's seat side and may be configured to display an operating speed of a vehicle, a running speed gauge that displays a vehicle speed, a rotating speed of a power unit (not shown) and a revolutions per minute (RPM) gauge that displays the number of revolutions of an engine. In this regard, only the vehicle speed and the number of revolutions of the engine will be described, but the disclosure is not limited thereto. Various types of vehicle information such as an interval meter value, an integrating meter value, a fuel meter value, a cooling water thermometer value and the like may be displayed.

The vehicle infotainment apparatus 200 implements an AVN function capable of providing not only route guidance information but also audio and video functions such as music, movie, radio, etc.

In an embodiment, the cluster 100 and the vehicle infotainment apparatus 200 may be connected to each another via a data interface and a display interface. In an embodiment, the data interface may be a wired or wireless data interface. The vehicle infotainment apparatus 200 may transmit and receive state information of the cluster 100 through the data interface. In an embodiment, the cluster 100 may periodically transmit a heartbeat message to the vehicle infotainment apparatus 200 and the vehicle infotainment apparatus 200 may determine whether the cluster 100 is in a normal state or an abnormal state. In an embodiment, a state of the cluster 100 is determined through transmission/reception of the heartbeat message, but the disclosure is not limited thereto. Various methods may be applied.

In an embodiment, the cluster 100 and the vehicle infotainment apparatus 200 may be connected to each other through a display interface to transmit and receive image information corresponding to vehicle information. In an embodiment, the display interface may include a high-definition multimedia interface (HDMI), a low voltage differential signal (LVDS) interface, etc. When the cluster 100 is in the abnormal state, for example, in a reset/reboot state, the vehicle infotainment apparatus 200 controls a display of the cluster 100. The vehicle infotainment apparatus 200 transmits the image information corresponding to the vehicle information to the cluster 100 through the display interface, and displays the image information on the display of the cluster 100.

Although not shown, the vehicle infotainment apparatus 200 may receive the vehicle information, for example, information about the vehicle speed from a vehicle control apparatus (not shown), for example, an engine control unit (ECU), through a controller area network (CAN).

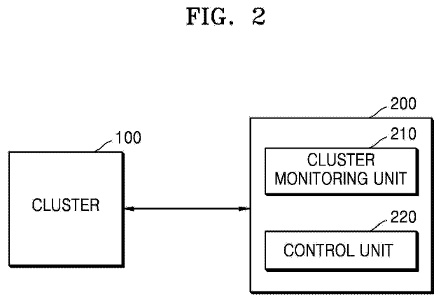

FIG. 2 is a schematic block diagram of the cluster 100 and vehicle infotainment apparatus 200 shown in FIG. 1.

Referring to FIG. 2, the vehicle infotainment apparatus 200 may include a cluster monitoring unit 210 and a control unit 220.

The cluster monitoring unit 210 may monitor a state of the cluster 100 displaying vehicle information including at least one of a vehicle speed of a vehicle and the number of revolutions of an engine.

The control unit 220 may receive state information of the cluster 100 from the cluster monitoring unit 210 and sets a cluster backup function according to the received state information. When the cluster monitoring unit 210 detects an abnormal state of the cluster 100, the control unit 220 sets the cluster backup function. In an embodiment, the cluster backup function means performing a display control function in relation to image information to be displayed on a display of the cluster 100.

In an embodiment, the control unit 220 may also display the image information according to the same graphical user interface (GUI) as a GUI of the cluster 100 on the display of the cluster 100. Alternatively, the control unit 220 may display a GUI different from the GUI of the cluster 100 on the display to display the image information.

In an embodiment, the cluster monitoring unit 210 may continuously monitor the state of the cluster 100 even after the cluster backup function is set and determine whether the state of the cluster 100 returns to a normal state. The control unit 220 may release the cluster backup function when the state of the cluster 100 returns to the normal state. In this case, image control of the display of the cluster 100 may be performed by the cluster 100 or the ECU.

In the embodiment described with reference to FIG. 2, the cluster monitoring unit 210 is included in the vehicle infotainment apparatus 200, but the cluster monitoring unit 210 may be included in the cluster 100 to monitor the abnormal state of the cluster 100. In this case, when the abnormal state of the cluster 100 is detected, the cluster monitoring unit 210 may transmit an abnormal signal corresponding to the abnormal state to the vehicle infotainment apparatus 200. In this case, when the cluster 100 returns to the normal state, the cluster monitoring unit 210 may transmit a normal signal corresponding to the normal state to the vehicle infotainment apparatus 200, and the vehicle infotainment apparatus 200 may end a screen control of the cluster 100.

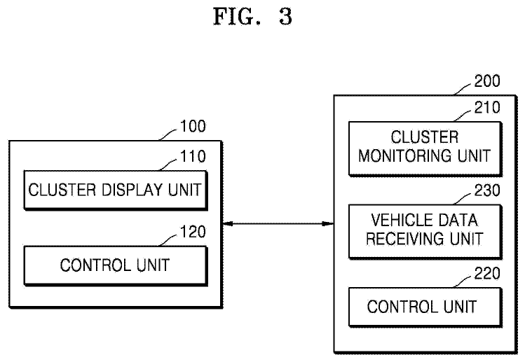

FIG. 3 is a schematic block diagram of the cluster 100 and the vehicle infotainment apparatus 200 according to another embodiment. Only different configurations between FIG. 3 and FIG. 2 will be described.

Referring to FIG. 3, the cluster 100 may further include a cluster display unit 110 and a control unit 120, and the vehicle infotainment apparatus 200 further includes a vehicle data receiving unit 230.

The cluster display unit 110 may display image information corresponding to vehicle information under the control of the control unit 120. In an embodiment, the control unit 120 may be an MPU or a processor. The control unit 120 transmits cluster state information to the cluster monitoring unit 210 of the vehicle infotainment apparatus 200. Also, the cluster monitoring unit 210 may periodically transmit a state request message to the control unit 120 to determine whether the cluster 100 is in a normal state or an abnormal state according to a response from the control unit 120.

The vehicle data receiving unit 230 receives vehicle data from an external vehicle control apparatus (not shown), for example, an ECU (Engine Control Unit), or sensors that receive the vehicle information. The vehicle data receiving unit 230 may be connected to the vehicle control apparatus (not shown) through a CAN communication interface. The vehicle data receiving unit 230 may receive the vehicle information from the vehicle control apparatus via the CAN communication interface.

The control unit 220 may transmit the image information corresponding to the vehicle information received by the vehicle data receiving unit 230 to the cluster display unit 110 when the cluster 100 is in the abnormal state. Therefore, even when the control unit 220 of the cluster 100 is in the abnormal state, the vehicle information may be stably displayed on the cluster display unit 110.

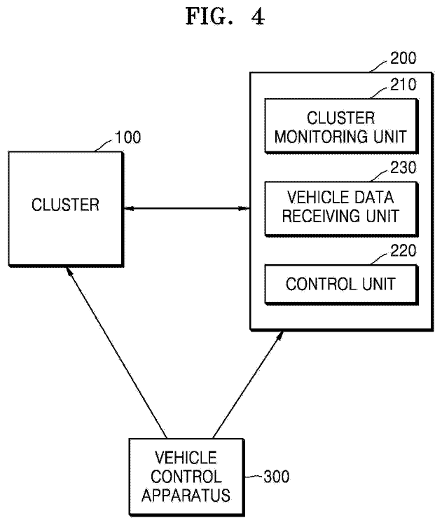

FIG. 4 is a schematic block diagram of the cluster 100 and the vehicle infotainment apparatus 200 according to yet another embodiment. Different configurations between FIG. 4 and FIGS. 2 and 3 will be described and the same configuration will not be described.

Referring to FIG. 4, each of the cluster 100 and the vehicle infotainment apparatus 200 is connected to a vehicle control apparatus 300. The cluster 100 and the vehicle infotainment apparatus 200 may be respectively connected via a data interface and a display interface. The vehicle control apparatus 300 may be connected via a CAN communication interface. The vehicle control apparatus 300 may be an ECU or sensors that sense vehicle information.

The cluster 100 and the vehicle infotainment apparatus 200 may receive the vehicle information from the vehicle control apparatus 300 and display the received vehicle information or image information corresponding to the vehicle information.

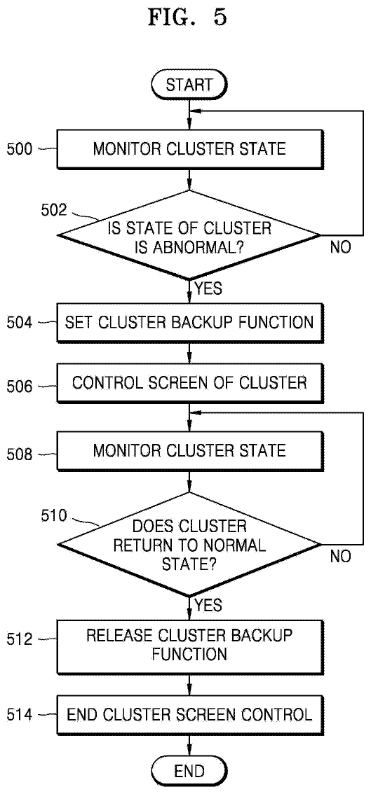

FIG. 5 is a flowchart for explaining a control method of a vehicle infotainment apparatus according to still another embodiment.

Referring to FIG. 5, in operation 500, a cluster state is monitored. The vehicle infotainment apparatus may determine the cluster state from a periodic heartbeat signal received from a cluster.

In operation 502, it is determined whether a state of the cluster is abnormal. In this regard, a case where the state of the cluster is abnormal means a case that a normal display control is not performed due to a reset or a reboot of the cluster or a MPU of the cluster.

In operation 504, when the cluster state is abnormal, a cluster backup function is set. The vehicle infotainment apparatus sets the cluster backup function when the state of the cluster is abnormal, and, in operation 506, controls a screen of the cluster. The vehicle infotainment apparatus may transmit image information corresponding to vehicle information to the cluster through a display interface, for example, a HDMI.

In operation 508, the cluster state is monitored. The vehicle infotainment apparatus continuously monitors the cluster state even after the cluster backup function is set.

In operation 510, it is determined whether the state of the cluster returns to a normal state. When the cluster returns from an abnormal state to the normal state, it is possible to determine whether the cluster returns to the normal state from the fact that an abnormal heartbeat signal is normally received again.

In operation 512, when the cluster returns to the normal state, the cluster backup function is released. The vehicle infotainment apparatus passes a display control authority of the cluster back to the cluster when the cluster returns to the normal state.

In operation 514, a cluster screen control ends.

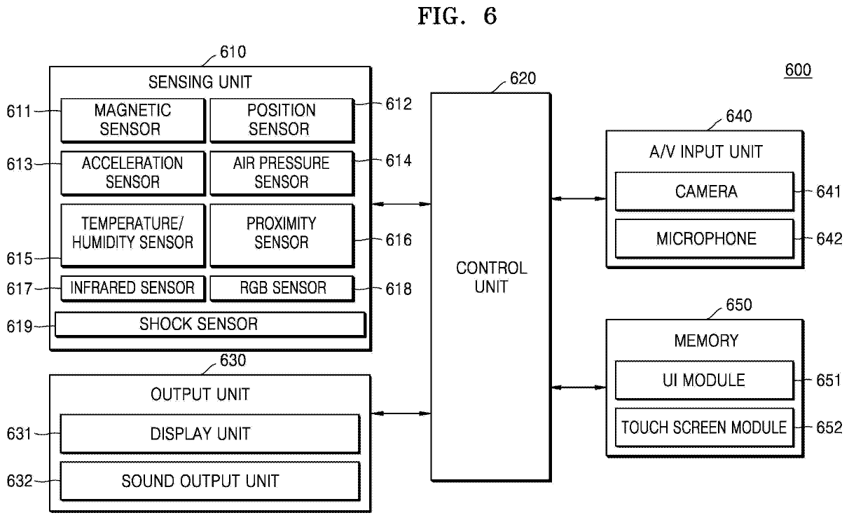

FIG. 6 is a detailed block diagram of a vehicle infotainment apparatus 600 according to another embodiment.

As shown in FIG. 6, the vehicle infotainment apparatus 600 may include a sensing unit 610, a control unit 620, an output unit 630, an A/V input unit 640, and a memory 650. However, all illustrated components are not indispensable components. The vehicle infotainment apparatus 600 may be implemented by more components than the components shown, and the vehicle infotainment apparatus 600 may be implemented by fewer components than the components.

The sensing unit 610 may include at least one of a magnetic sensor 611, an acceleration sensor 613, a temperature/humidity sensor 615, an infrared sensor 617, a position sensor (e.g. a GPS) 612, an air pressure sensor 614, a proximity sensor 616, and an RGB sensor 618, but is not limited thereto. A function of each sensor may be intuitively deduced from the name by a person skilled in the art, and thus a detailed description thereof will be omitted.

The control unit 620 typically controls the overall operation of the vehicle infotainment apparatus 600. For example, the control unit 620 generally controls the sensing unit 610, the output unit 630, the A/V input unit 640, and the memory 650 by executing programs stored in the memory 650.

As described with reference to FIGS. 2 to 4, the control unit 620 is connected to a cluster through a display interface, when an abnormal state of the cluster is detected, sets a cluster backup function and transmits image information corresponding to vehicle information to the cluster through the display interface.

The output unit 630 is configured to perform an operation determined by the control unit 620 and may include a display unit 631 and a sound output unit 632. Also, as described with reference to FIGS. 2 to 4, when the cluster backup function is set, the output unit 630 may transmit the image information corresponding to the vehicle information to the cluster through the display interface.

The sound output unit 632 outputs audio data. Also, the sound output unit 632 outputs a sound signal related to a function (e.g., a notification sound) performed in the vehicle infotainment apparatus 600. The sound output unit 632 may include a speaker, a buzzer, and the like.

The A/V input unit 640 is used to input an audio signal or a video signal, and may include a camera 641, a microphone 642, and the like. The camera 641 may obtain an image frame such as a still image or a moving image through an image sensor in a video communication mode or a capturing mode. An image captured through the image sensor may be processed through the control unit 620 or a separate image processing unit (not shown).

The image frame processed by the camera 641 may be stored in the memory 650 or may be transmitted to the outside through a communication unit (not shown). The microphone 642 receives an external sound signal and processes the external sound signal into electrical voice data. For example, the microphone 642 may receive a voice input of a user. The microphone 642 may use various noise reduction algorithms to remove noise generated in receiving the external sound signal.

The memory 650 may store a program for processing and controlling the control unit 620 and may store input/output data. Further, the memory 650 may store vehicle information, for example, a vehicle speed, the number of resolutions of an engine, and the like, received from a vehicle control apparatus.

The memory 650 according to an embodiment may store a plurality of operating systems. The memory 650 may also store an application running on each of the plurality of operating systems. The memory 650 may also store a graphical user interface program to be displayed on a display of the cluster.

The programs stored in the memory 650 may be classified into a plurality of modules according to their functions, for example, a UI module 651, a touch screen module 652, etc.

Various sensors may be provided in or near a touch screen to detect a touch or a proximity touch of the touch screen. An example of a sensor for sensing the touch of the touch screen is a tactile sensor. The tactile sensor is a sensor that detects a contact of a specific object to a degree or more that a person feels. The tactile sensor may sense various types of information such as the roughness of a contact surface, the rigidity of a contact object, and the temperature of a contact point. Also, a proximity sensor is an example of a sensor for sensing the touch of the touch screen.

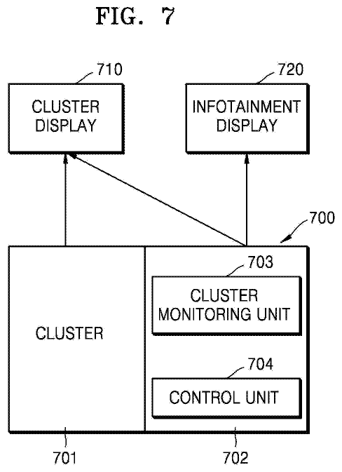

FIG. 7 is an example diagram illustrating a cluster 701 and a vehicle infotainment apparatus 702 implemented as one device 700 according to another embodiment. In this regard, the device 700 may be a vehicle control apparatus or a processor.

Referring to FIG. 7, the device 700 may include the cluster 701 and the vehicle infotainment apparatus 702. The device 700 may be provided with two operating systems (hereinafter referred to as OSs) that include a first OS driving the cluster 701 and a second OS driving the vehicle infotainment apparatus 702. The cluster 701 may control a cluster display 710. The vehicle infotainment apparatus 702 may control an infotainment display 720.

In an embodiment, a cluster monitoring unit 703 may monitor a state of the cluster 701, when the cluster 701 is in an abnormal state, and a control unit 704 of the vehicle infotainment apparatus 702 may perform a cluster backup function of controlling the cluster display 710. Also, when the cluster 701 returns to a normal state, the cluster backup function is released, and the cluster 701 again controls the cluster display 710.

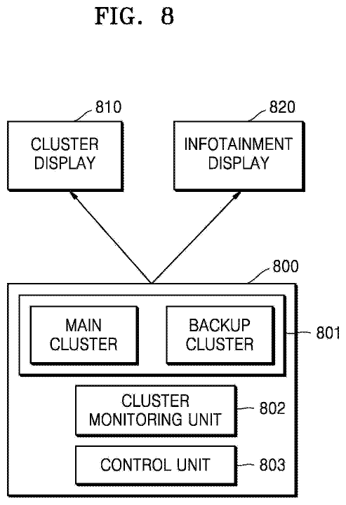

FIG. 8 is an example diagram illustrating a cluster and a vehicle infotainment apparatus implemented as one device 800 according to yet another embodiment. The same descriptions as presented with respect to FIG. 7 will be omitted, and only differences between FIGS. 7 and 8 will be described.

Referring to FIG. 8, the device 800 includes a cluster function module 801, a cluster monitoring unit 802, and a control unit 803. The device 800 has one OS to control a cluster display 810 and an infotainment display 820. The cluster function module 801 includes a main cluster module and a backup cluster module. When the cluster operates normally, the cluster function module 801 controls the cluster display 810 according to the main cluster. In an embodiment, in case of an abnormal state of the main cluster module, the backup cluster module may operate to control the cluster display 810.

The apparatus described herein may include a processor, a memory for storing program data to be executed by the processor, a permanent storage such as a disk drive, a communications port for handling communications with external devices, and user interface devices, including a display, keys, etc. When software modules are involved, these software modules may be stored as program instructions or computer readable code executable by the processor on a non-transitory computer-readable media such as read-only memory (ROM), random-access memory (RAM), CD-ROMs, magnetic tapes, floppy disks, and optical data storage devices. The computer readable recording media may also be distributed over network coupled computer systems so that the computer readable code is stored and executed in a distributed fashion. This media may be read by the computer, stored in the memory, and executed by the processor.

For the purposes of promoting an understanding of the principles of the disclosure, reference has been made to the embodiments illustrated in the drawings, and specific language has been used to describe these embodiments. However, no limitation of the scope of the disclosure is intended by this specific language, and the disclosure should be construed to encompass all embodiments that would normally occur to one of ordinary skill in the art.

The disclosure may be described in terms of functional block components and various processing steps. Such functional blocks may be realized by any number of hardware and/or software components configured to perform the specified functions. For example, the disclosure may employ various integrated circuit components, e.g., memory elements, processing elements, logic elements, look-up tables, and the like, which may carry out a variety of functions under the control of one or more microprocessors or other control devices. Similarly, where the elements of the disclosure are implemented using software programming or software elements, the disclosure may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Furthermore, the disclosure may employ any number of conventional techniques for electronics configuration, signal processing and/or control, data processing and the like. The words “mechanism” and “element” are used broadly and are not limited to mechanical or physical embodiments, but may include software routines in conjunction with processors, etc.

The particular implementations shown and described herein are illustrative examples of the disclosure and are not intended to otherwise limit the scope of the disclosure in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. Moreover, no item or component is essential to the practice of the disclosure unless the element is specifically described as “essential” or “critical.”

The use of the terms “a” and “an” and “the” and similar referents in the context of describing the disclosure (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein may be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. Numerous modifications and adaptations will be readily apparent to those of ordinary skill in this art without departing from the spirit and scope of the disclosure.

What is claimed is:

1. A vehicle infotainment apparatus comprising:
a cluster monitoring unit configured to monitor a state of a cluster displaying vehicle information comprising at least one of a vehicle speed of a vehicle and a number of revolutions per minute of an engine of the vehicle; and
a control unit configured to receive state information of the cluster from the cluster monitoring unit and set a cluster backup function according to the received state information,
wherein, when the cluster monitoring unit detects an abnormal state of the cluster, the control unit is configured to set the cluster backup function.

2. The vehicle infotainment apparatus of claim 1, wherein the control unit is configured to control the cluster to display the vehicle information on a screen of the cluster according to the cluster backup function.

3. The vehicle infotainment apparatus of claim 1, further comprising:
a vehicle information receiving unit connected to a vehicle control apparatus through a controller area network (CAN) communication interface and configured to receive the vehicle information from the vehicle control apparatus through the CAN communication interface.

4. The vehicle infotainment apparatus of claim 1, wherein, when the cluster monitoring unit detects a normal state of the cluster, the control unit is configured to release the set cluster backup function.

5. The vehicle infotainment apparatus of claim 1, further comprising:
a data interface configured to receive the state information from the cluster; and
a display interface configured to transmit image information corresponding to the vehicle information to the cluster.

6. The vehicle infotainment apparatus of claim 5, wherein the cluster monitoring unit is connected to the cluster through a data interface and is configured to monitor a state of the cluster by receiving a heartbeat message from the cluster.

7. The vehicle infotainment apparatus of claim 5, wherein the control unit is connected to the cluster through a display interface and configured to transmit image information corresponding to vehicle information to a screen of the cluster through the display interface when the cluster is in an abnormal state.

8. The vehicle infotainment apparatus of claim 7, wherein the image information is same as a graphical user interface of the image information displayed on the screen when the cluster is in a normal state.

9. The vehicle infotainment apparatus of claim 7, wherein the image information is different from a graphical user interface of the image information displayed on the screen when the cluster is in a normal state.

10. A control method of a vehicle infotainment apparatus, the control method comprising:
monitoring a state of a cluster displaying vehicle information comprising at least one of a vehicle speed of a vehicle and a number of revolutions per minute of an engine of the vehicle;
receiving state information of the cluster from the cluster monitoring unit; and
setting a cluster backup function according to the received state information,
wherein the setting comprises, when an abnormal state of the cluster is detected, setting the cluster backup function.

11. The control method of claim 10, wherein the setting comprises controlling the cluster to display the vehicle information on a screen of the cluster according to the cluster backup function.

12. The control method of claim 10, further comprising:
receiving the vehicle information from the vehicle control apparatus through a controller area network (CAN) communication interface.

13. The control method of claim 10, further comprising:
releasing the set cluster backup function when a normal state of the cluster is detected.

14. A cluster apparatus of a vehicle, the cluster apparatus comprising:
a cluster monitoring unit mounted on the vehicle and configured to monitor a state of a cluster displaying one or more information of a vehicle speed of the vehicle or a number of revolutions per minute of an engine of the vehicle; and
a communication interface unit configured to communicate with an infotainment apparatus mounted on the vehicle,
wherein, when a display of the cluster does not normally operate, the cluster monitoring unit is configured to transmit a cluster malfunction signal to the infotainment apparatus through the communication interface unit.

15. The cluster apparatus of claim 14, wherein, when the cluster malfunction signal is transmitted to the infotainment apparatus, a screen of the cluster apparatus is controlled by the infotainment apparatus.

16. The cluster apparatus of claim 15, wherein, when it is determined that the cluster is operating normally again, the cluster monitoring unit is configured to transmit a normal operation signal to the infotainment apparatus through the communication interface unit.
